(19) United States
(12) Patent Application Publication
(10) Pub. No.: US 2025/0063129 A1
(43) Pub. Date: Feb. 20, 2025

(54) INFORMATION PROCESSING SYSTEM AND NON-TRANSITORY COMPUTER-READABLE STORAGE MEDIUM

(71) Applicant: FUJIFILM Business Innovation Corp., Tokyo (JP)

(72) Inventor: Naoyuki Kato, Kanagawa (JP)

(73) Assignee: FUJIFILM Business Innovation Corp., Tokyo (JP)

(21) Appl. No.: 18/592,603

(22) Filed: Mar. 1, 2024

(30) Foreign Application Priority Data
Aug. 17, 2023 (JP) 2023-133068

(51) Int. Cl. H04N 5/16; G06V 10/141; G06V 10/60

(52) U.S. Cl. CPC H04N 5/165; G06V 10/141; G06V 10/60

(57) ABSTRACT

An information processing system includes: a light source that illuminates a document; an image sensor that reads an image of the document; and at least one processor, wherein when incidence of external light is detected from output data of the image sensor, the at least one processor moves the image sensor in a direction opposite to a reading direction from a first position for starting reading of the document in a stationary state, and corrects a black level of the image sensor at a second position where an entire light receiving surface of the image sensor is hidden by a housing.

### CROSS-REFERENCE TO RELATED APPLICATIONS

This application is based on and claims priority under 35 USC 119 from Japanese Patent Application No. 2023-133068 filed Aug. 17, 2023.

### BACKGROUND

### (i) Technical Field

The present invention relates to an information processing system and a non-transitory computer-readable storage medium.

### (ii) Related Art

A so-called scanner reads an image of a document by using an image sensor driven relative to the document. Before an image is read by the scanner, black level correction is executed to remove the influence of external light on the image to be read.

### SUMMARY

As a black level correction technology, there is a technology of correcting the black level at a position where the influence of external light is likely to appear, based on the amount of received light at a position where the influence of external light is unlikely to appear. However, this type of technology cannot cope with a case where the influence of external light reaches the entire region of the image sensor.

Aspects of non-limiting embodiments of the present disclosure relate to an information processing system capable of realizing a black level correction technology with less restriction required for an image sensor, as compared with a black level correction technology that requires the presence of a position where the influence of external light is unlikely to appear and a position where the influence of external light is likely to appear on an image sensor.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising:
a light source that illuminates a document;
an image sensor that reads an image of the document; and
at least one processor,
wherein when incidence of external light is detected from output data of the image sensor, the at least one processor moves the image sensor in a direction opposite to a reading direction from a first position for starting reading of the document in a stationary state, and corrects a black level of the image sensor at a second position where an entire light receiving surface of the image sensor is hidden by a housing.

### BRIEF DESCRIPTION OF THE DRAWINGS

Exemplary embodiments of the present invention will be described in detail based on the following figures, wherein:

FIG. 1 is a diagram depicting an external configuration example of an image forming apparatus assumed in a first exemplary embodiment;

FIG. 2 is a diagram for describing an example of an internal configuration of the image forming apparatus;

FIG. 3 is an exploded view of the vicinity of a document table of an apparatus body used in the first exemplary embodiment;

FIG. 4 is a diagram for describing an incident path of external light;

FIG. 5 is a diagram for describing a relationship between a pixel position and black data when external light enters a housing;

FIG. 6 is a flowchart for describing a processing operation adopted in the first exemplary embodiment;

FIG. 7 is a diagram for describing prediction correction;

FIG. 8 is a diagram for describing blocking of external light by a person;

FIG. 9 is an exploded view of the vicinity of a document table of an apparatus body used in a second exemplary embodiment;

FIG. 10 is a flowchart for describing a processing operation adopted in the second exemplary embodiment;

FIG. 11 is a diagram for describing a movement of an image reading unit to the left end in a housing; and

FIG. 12 is a flowchart for describing a processing operation adopted in a third exemplary embodiment.

### DETAILED DESCRIPTION

Hereinafter, exemplary embodiments of the present invention will be described with reference to the drawings.

### First Exemplary Embodiment

### Appearance Configuration

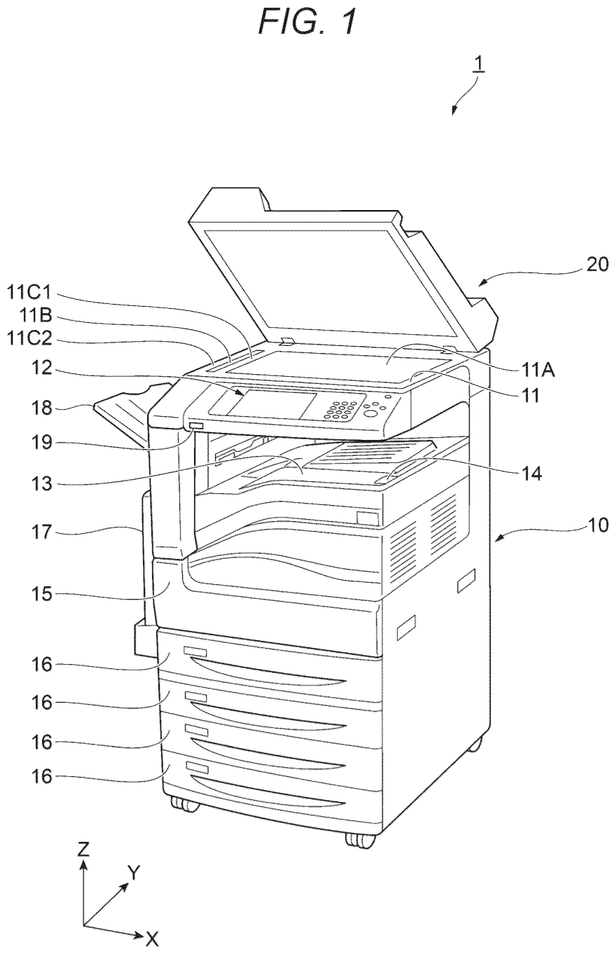

FIG. 1 is a diagram depicting an external configuration example of an image forming apparatus 1 assumed in a first exemplary embodiment. The image forming apparatus 1 illustrated in FIG. 1 represents one form of an apparatus (a so-called multifunction machine) used in an office. Thus, the image forming apparatus 1 has a printing function, a copy printing function, a facsimile function, a scanner function, and other functions. The image forming apparatus 1 described in the first exemplary embodiment is an example of an information processing system.

The image forming apparatus 1 has a structure in which a document conveying unit 20 is attached to an upper surface of an apparatus body 10. The apparatus body 10 is provided with a document table 11, an operation panel 12, a center tray 13, a power switch 14, a front cover 15, a paper tray 16, a manual feed tray 17, a side tray 18, and a motion sensor 19. In FIG. 1, a sub-scanning direction is defined as an X axis, and a main scanning direction is defined as a Y axis. A vertically upward direction is defined as a Z axis.

The document table 11 is provided with a document glass 11A for reading an image from a document placed on a glass surface (hereinafter, referred to as “image”) and a document reading glass 11B for reading an image from a document conveyed at a constant speed by the document conveying unit 20.

The document glass 11A and the document reading glass 11B are separated from each other in the X-axis direction by a band-shaped member 11C1 that forms part of the document table 11. The long side of the band-shaped member 11C1 on the document glass 11A side defines a reading start position of an effective reading range in the document glass 11A. The long sides of the band-shaped member 11C1 is parallel to the Y axis. The band-shaped member 11C1 is made of a material that does not transmit light, similarly to the other parts of a housing.

A band-shaped member 11C2 forming one outer edge portion of the document table 11 is disposed on the opposite side of the band-shaped member 11C1 with respect to the document reading glass 11B. The long sides of the band-shaped member 11C2 are also parallel to the Y axis. The band-shaped member 11C2 is made of a material that does not transmit light, similarly to the other parts of the housing.

The operation panel 12 is provided with a button, a lamp, a capacitive touch panel, and the like related to operation. Further, the motion sensor 19 is attached to a part of the operation panel 12.

Paper on which an image is printed is discharged to the center tray 13 with its printed surface facing downward. The image here includes an image received from an external terminal as a print job, an image read from a document, and the like.

The power switch 14 is used for turning on/off the power of the apparatus body.

The front cover 15 is a cover that is opened at the time of replacing a consumable product or at the time of an on/off operation of a main power. In the present exemplary embodiment, the side to which the operation panel 12 and the front cover 15 are attached is referred to as a front, and the side to which a hinge for opening and closing the document conveying unit 20 is attached is referred to as a back.

The paper tray 16 is a tray for storing paper to be used for printing. The paper tray 16 is also referred to as a paper feed tray.

The manual feed tray 17 is a tray used when an image is to be printed on paper of a type that is not stored in the paper tray 16.

Paper on which an image is printed is discharged to the side tray 18 with the printed surface facing upward.

The motion sensor 19 is a sensor that detects a person who operates the operation panel 12, and for example, an infrared sensor is used. In the case of the present exemplary embodiment, the motion sensor 19 is provided near the front of the document reading glass 11B.

### Internal Configuration

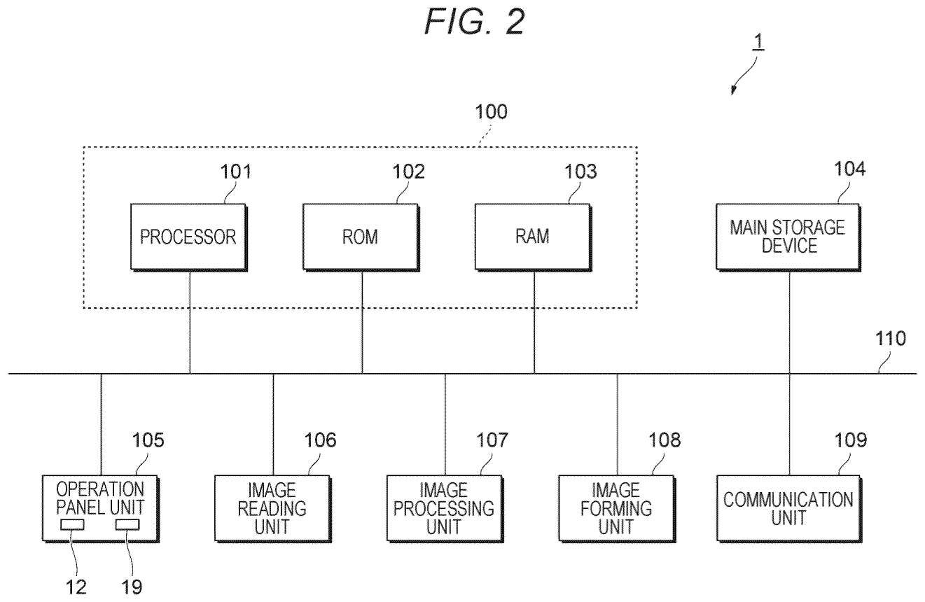

FIG. 2 is a diagram for describing an example of an internal configuration of the image forming apparatus 1.

The image forming apparatus 1 includes a control unit 100, a main storage device 104, an operation panel unit 105, an image reading unit 106, an image processing unit 107, an image forming unit 108, a communication unit 109, and a signal line 110 such as a bus that connects these units. The control unit 100 includes a processor 101, a read only memory (ROM) 102, and a random access memory (RAM) 103.

The processor 101 is a processing device that realizes various functions by executing a program read from the ROM 102 using the RAM 103 as a work area. For example, a basic input output system (BIOS) and firmware are stored in the ROM 102.

The main storage device 104 is, for example, a hard disk device or a semiconductor memory, and is used to store image data received as a print job or image data read by the image reading unit 106.

The operation panel unit 105 is a device constituted by the operation panel 12 (see FIG. 1) and the motion sensor 19 (see FIG. 1). The operation panel unit 105 is used for displaying an operation screen, accepting a person's operation, detecting the presence of a person who operates the operation panel 12, and the like.

The image reading unit 106 is a device that reads an image of a document placed on the document table 11 or a document conveyed by the document conveying unit 20, and is provided in a space below the document table 11 (see FIG. 1). In the present exemplary embodiment, a contact image sensor (CIS) type sensor is used as the image reading unit 106.

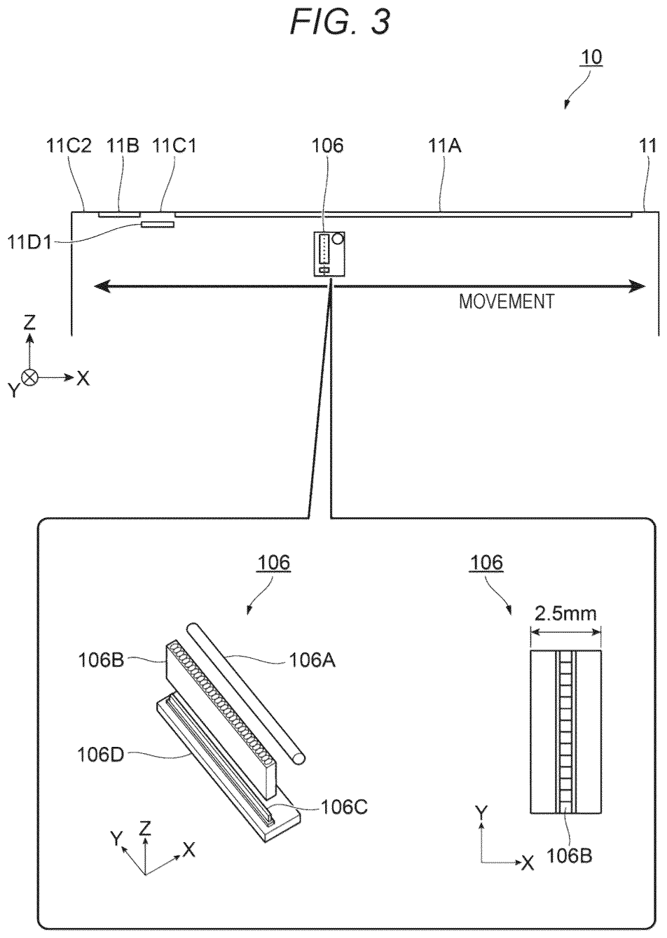

FIG. 3 is an exploded view of the vicinity of the document table 11 of the apparatus body 10 used in the first exemplary embodiment. In FIG. 3, components corresponding to those in FIGS. 1 and 2 are denoted by corresponding reference numerals.

In the case of the present exemplary embodiment, a white reference plate 11D1 is attached to the lower surface side of the band-shaped member 11C1.

The image reading unit 106 is movable in the X-axis direction inside the apparatus body 10. For example, when an image of a document placed on the document glass 11A is read, the image reading unit 106 is moved in the sub-scanning direction from the vicinity of the lower part of the white reference plate 11D1. On the other hand, when an image of a document conveyed by the document conveying unit 20 is read, the image reading unit 106 is positioned at a lower part of the document reading glass 11B.

The image reading unit 106 includes a light source 106A, an imaging lens 106B, an image sensor 106C, and a stage 106D.

The light source 106A is, for example, a light emission diode (LED) light source. Although omitted in FIG. 3, light sources 106A corresponding to respective colors of red (R), green (G), and blue (B) are arranged for color reading. Illumination light output from the light source 106A is guided to a glass surface through a transparent light guide plate.

The imaging lens 106B is a lens array in which cylindrical equal magnification lenses are arranged in the Y-axis direction. For the imaging lens 106B, for example, a gradient-index lens (SLA: SELFOC (registered trademark) lens array) is used. In the present exemplary embodiment, the image reading unit 106 accommodating the imaging lens 106B has a width of 2.5 mm in the X-axis direction. As illustrated in FIG. 3, the opening width of the imaging lens 106B is one severalth of the width of the image reading unit 106 in the X-axis direction.

The image sensor 106C is a device that reads the optical image formed in a linear shape.

The stage 106D is a pedestal part of the image sensor 106C.

Return to the description of FIG. 2.

The image processing unit 107 is configured as, for example, a dedicated processor or processing board, and is a device that executes image processing such as color correction and gradation correction on image data.

The image forming unit 108 is a so-called printing engine. The image forming unit 108 includes an engine of an electrophotographic type and an engine of an inkjet type. In the case of the image forming unit 108 supporting color printing, for example, four colors of yellow (Y), magenta (M), cyan (C), and black (K) are used as coloring materials.

The communication unit 109 includes, for example, a modem or a LAN interface, and is used for facsimile communication or communication with an external apparatus.

### Incident Path of External Light

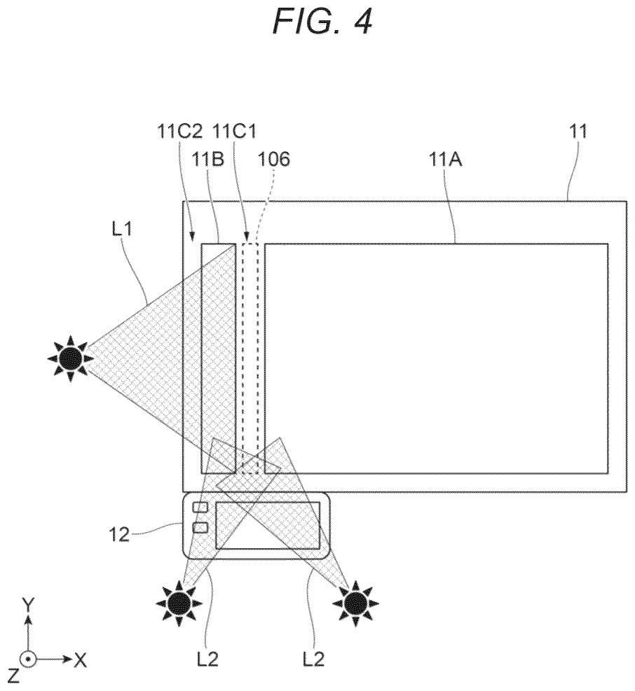

FIG. 4 is a diagram illustrating incident paths of external light L1 and L2. Although the document conveying unit 20 is not illustrated in FIG. 4, the actual document conveying unit 20 is closed. That is, the actual document conveying unit 20 covers the entire upper surface of the document table 11.

In the case of FIG. 4, the image reading unit 106 is positioned below the band-shaped member 11C1.

Even when the document conveying unit 20 is closed, a gap is formed between the document table 11 and the document conveying unit 20. For this reason, in the case of an environment in which external light is incident on the image forming apparatus 1 from a substantially horizontal direction, two types of incident paths are considered.

One of the incident paths is an incident path of external light L1. In the case of the external light L1, the entire long side of the document reading glass 11B serves as an entrance of the external light L1.

The other one of the incident paths is an incident path of the external light L2. In the case of the external light L2, the front-side end portion of the document reading glass 11B or the front-side end portion of the document glass 11A serves as an entrance of the external light L2.

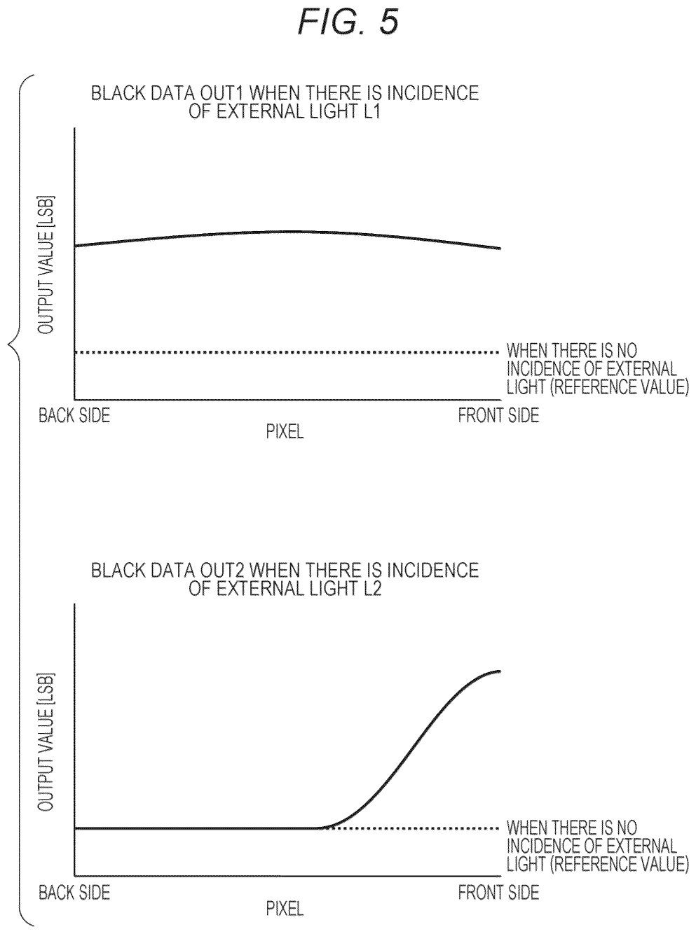

FIG. 5 is a diagram for describing a relationship between a pixel position and black data OUT when external light enters a housing. Here, the black data OUT is a value output from the image sensor 106C in a state where the light source 106A is turned off (hereinafter, also referred to as “output value”).

The horizontal axis corresponds to the pixel position of the image sensor 106C, and the vertical axis is the smallest bit.

When there is entrance of the external light L1, the entire document reading glass 11B is an entrance as described in FIG. 4. Thus, a black data OUT1 indicated by the thick line is uniformly high from the back side to the front side of the image sensor 106C (see FIG. 3). The black data OUT1 indicated by the broken line represents an output value when there is no influence of external light.

On the other hand, when there is incidence of the external light L2, only the front-side end portion of the document glass 11A or the document reading glass 11B serves as an entrance, as described with reference to FIG. 4. Thus, the black data OUT1 indicated by the thick line becomes high near the front side of the image sensor 106C (see FIG. 3). The external light L2 does not reach the back side, and thus, the black data OUT1 in the vicinity of the back side has substantially the same value as the output value when there is no influence of the external light.

Hereinafter, the output value indicated by the broken line is referred to as a reference value of the black data OUT. The reference value is obtained at the time of shipment from a factory, at the time of installation of the image forming apparatus 1, or at the time of execution in which the presence of external light is not detected, and is written in, for example, the ROM 102 (see FIG. 2) or the RAM 103 (see FIG. 2).

### Black Correction

For the image forming apparatus 1, a function of correcting the black level of the image sensor 106C to make the black level fall within a normal range (hereinafter referred to as “black correction”) is prepared. The black correction is called auto offset control (AOC), and is executed, for example, at the time of power-on or at the time of return from a power saving state.

There is an upper limit to the amount of adjustment of the output value OUT with the AOC. Thus, the output value after the correction with the AOC does not fall within the normal range in some cases. In this case, the image reading unit 106 may be determined as a failure although it is normal.

### Processing Operation

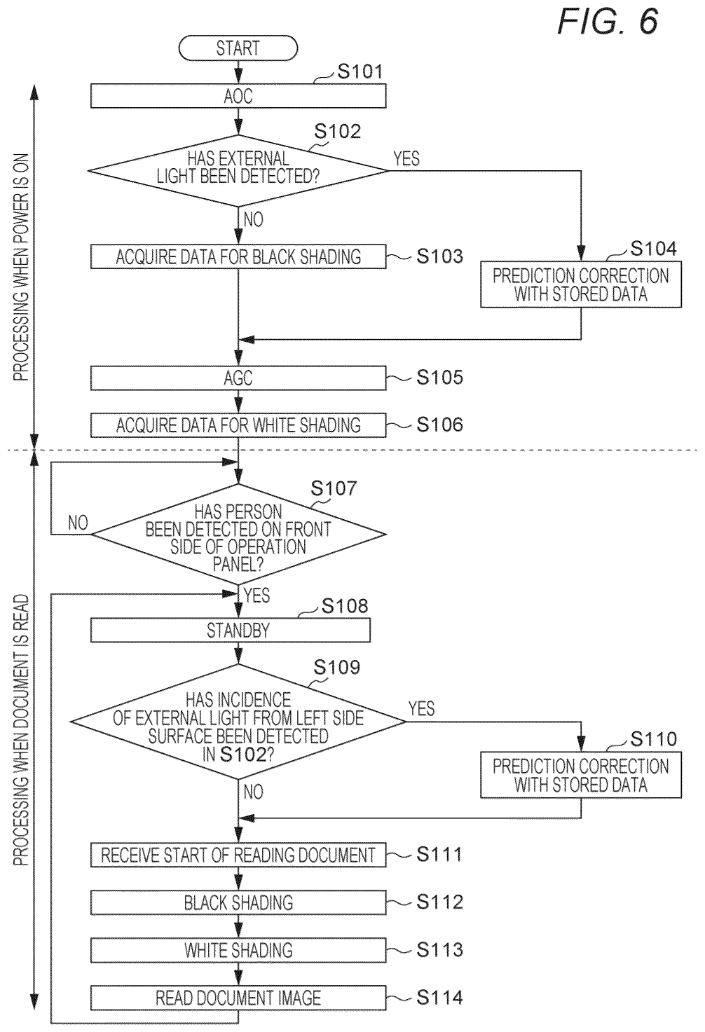

FIG. 6 is a flowchart for describing a processing operation adopted in the first exemplary embodiment. The symbol S illustrated in the drawings means a step.

The processing operation illustrated in FIG. 6 is started when an on-operation of the power switch 14 (see FIG. 1) is detected by the processor 101 (see FIG. 2) or when return from a power saving state is detected by the processor 101 (see FIG. 2).

### Processing at the Time of Power-on

First, the processor 101 adjusts the offset amount of the black data OUT of the image sensor 106C (see FIG. 3) (Step 101). That is, the AOC is executed. The AOC herein is executed at the position of the band-shaped member 11C1 (see FIG. 3).

Next, the processor 101 detects the presence or absence of external light entering the housing from the black data OUT acquired at the time of execution of Step 101 (Step 102). For example, when a pixel in which the difference between the black data OUT and the reference value exceeds a threshold is found, the processor 101 determines that external light entering the housing is detected.

To avoid erroneous detection due to individual differences or abnormal values of the image reading unit 106 (see FIG. 2), the image sensor 106C may be divided into a plurality of sections in the Y-axis direction, and the presence or absence of external light entering the housing may be determined based on the difference between the mean value of the black data OUT for each section and the reference value.

When no external light is detected, a negative result is obtained in Step 102. In this case, the processor 101 acquires data for black shading (Step 103). Specifically, the black data after the AOC is acquired as data for black shading.

On the other hand, when external light is detected, an affirmative result is obtained in Step 102. In this case, the processor 101 performs prediction correction with the stored data (Step 104).

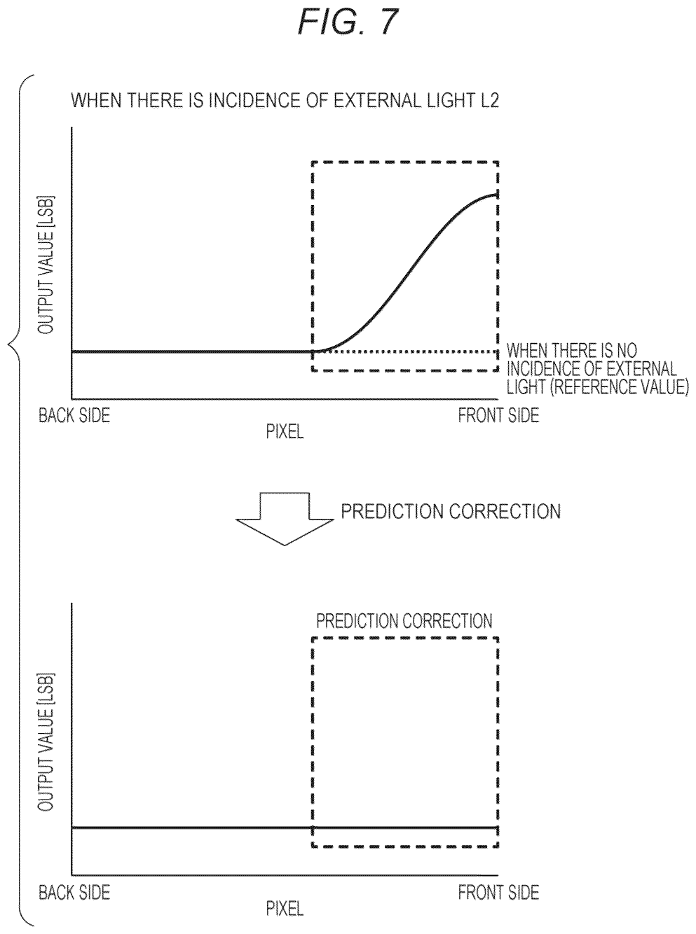

FIG. 7 is a diagram for describing prediction correction. In FIG. 7, components corresponding to those in FIG. 5 are denoted by corresponding reference numerals.

In FIG. 7, it is assumed that there is incidence of the external light L2. In FIG. 7, black data OUT2 before and after the prediction correction is indicated by thick lines. The upper diagram of FIG. 7 is the black data OUT2 before the prediction correction, and the lower diagram is the black data OUT2 after the prediction correction.

In the case of the upper part of FIG. 7, the black data OUT2 on the front side is larger than the reference value. Thus, it is determined that the external light L2 (see FIG. 4) is entering the housing from the front side. In this case, the processor 101 replaces the black datum OUT2 larger than the reference value with the reference value. In FIG. 7, the target portion of the prediction correction is surrounded by a broken line.

When the external light L1 (see FIG. 4) enters the housing from the side surface side, the processor 101 replaces all of the black data OUT1 with the reference value at the time of the prediction correction.

Return to the description of FIG. 6.

After execution of Step 103 or Step 104, the processor 101 automatically adjusts the white gain (Step 105). That is, auto gain control (AGC) is executed. Specifically, the gain is adjusted based on an output value output from the image sensor 106C (see FIG. 3) in a state where the light source 106A (see FIG. 3) is turned on. Next, the processor 101 acquires data for white shading (Step 106). Specifically, the output value after the gain adjustment is acquired as the data for white shading.

Thus, the initial processing associated with power-on or the like ends.

### Processing in Document Reading

Processing operation to be executed each time a document is read will be described below.

First, the processor 101 determines whether a person is detected on the front side of the operation panel 12 (see FIG. 1) (Step 107). For this determination, an output signal of the motion sensor 19 (see FIG. 1) is used.

When no person is detected, a negative result is obtained in Step 107. In this case, there is no possibility that an operation of reading a document by a person is performed. Thus, the processor 101 repeats the determination of Step 107.

On the other hand, when a person is detected, an affirmative result is obtained in Step 107. In this case, the processor 101 enters an operation standby state (Step 108). At this time, the image reading unit 106 is positioned below the band-shape member 11C1.

Next, the processor 101 determines whether incidence of external light from the left side surface has been detected in the determination of Step 102 (Step 109). In this determination, for example, the black data OUT after the AOC in Step 101 is referred to.

For example, when incidence of the external light L1 (see FIG. 4) has been detected, an affirmative result is obtained in Step 109. In this case, the processor 101 performs prediction correction with the stored data (Step 110). The prediction correction executed in Step 110 is the same as the prediction correction executed in Step 104. In the prediction correction in Step 110, the black data OUT1 corresponding to all pixels of the image sensor 106C (see FIG. 3) is replaced with the reference value.

On the other hand, when no external light from the side surface side is detected, a negative result is obtained in Step 109. For example, when a negative result is obtained in Step 102, a negative result is also obtained in Step 109.

A negative result is obtained in Step 109 even when incidence of the external light L2 (see FIG. 4) has been detected in Step 102. This is because a person is present on the front side of the operation panel 12, and incidence of the external light L2 into the housing is blocked at the time of this determination (that is, in the standby state).

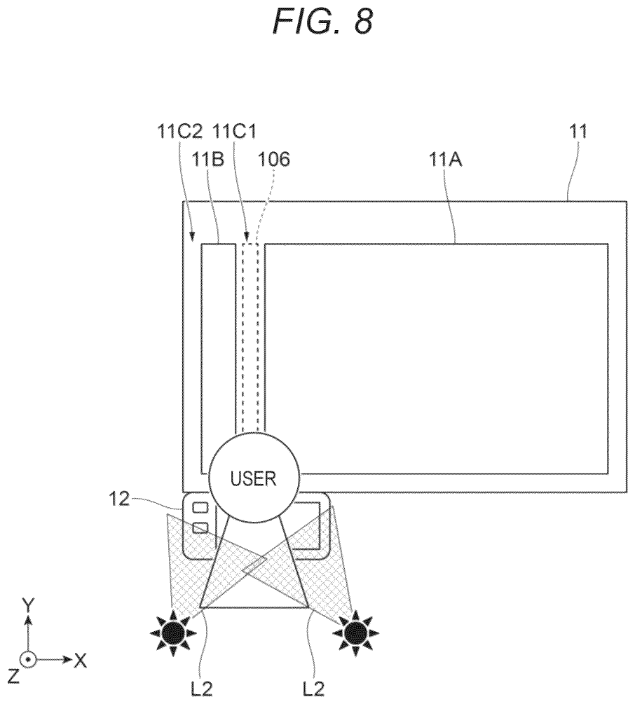

FIG. 8 is a diagram for describing blocking of the external light L2 by a person. In FIG. 8, components corresponding to those in FIG. 4 are denoted by corresponding reference numerals.

As illustrated in FIG. 8, the external light L2 is blocked by a person who operates the operation panel 12. Thus, it is possible to consider that there is no incidence of the external light L2 into the housing.

Return to the description of FIG. 6.

After a negative result is obtained in Step 109, or when the start of reading of a document is accepted after the execution of Step 110 (Step 111), the processor 101 executes black shading (Step 112) and white shading (Step 113), and executes reading of the document image (Step 114).

When the reading of the document image is completed, the processor 101 returns to Step 108 to prepare for the next reading.

### SUMMARY

The above-described image forming apparatus 1 (see FIG. 1) includes the apparatus body 10 (see FIG. 1), the document conveying unit 20 (see FIG. 1) that is opened and closed with a hinge provided on a back side of the apparatus body 10, the light source 106A (see FIG. 3) that illuminates a document, the image sensor 106C (see FIG. 3) that reads an image of the document, and the processor 101 (see FIG. 2).

Thus, there are two incident paths of external light that affects the correction of the black data OUT. Specifically, the incident path are two gaps, that is, a gap on the left side when the apparatus is viewed from the front and a gap on the front side of the apparatus.

In the case of the present exemplary embodiment, when incidence of external light is detected in the determination in Step 102, the processor 101 corrects the black level of the image sensor 106C using a normal value (that is, a value not affected by external light) stored at the time of shipment from a factory or the like regardless of the incidence direction of external light.

When no incidence of external light is detected in the determination of Step 102, the processor 101 uses the correction result of the black level executed in Step 101 as it is.

After the power is turned on, when incidence of the external light L1 from the left side surface side is detected in the determination of Step 102, the black level of the image sensor 106C is corrected by using the normal value (that is, a value not affected by external light) stored at the time of shipment from a factory or the like.

After the power is turned on, the correction result of the black level of the image sensor 106C executed in Step 101 is used as it is even when incidence of the external light L2 from the front side is detected in the determination of Step 102.

When no person is detected in Step 107, the processor 101 does not execute the black level correction processing corresponding to the direction of incidence of external light.

In this manner, in the case of the image forming apparatus 1 described in the present exemplary embodiment, a black level correction technology with less restriction required for the image sensor 106C is realized.

### Second Exemplary Embodiment

### External Configuration and Internal Configuration

Also in the present exemplary embodiment, the image forming apparatus 1 having the appearance configuration illustrated in FIG. 1 is used. The internal configuration of the image forming apparatus 1 is also basically the same as the internal configuration described with reference to FIG. 2.

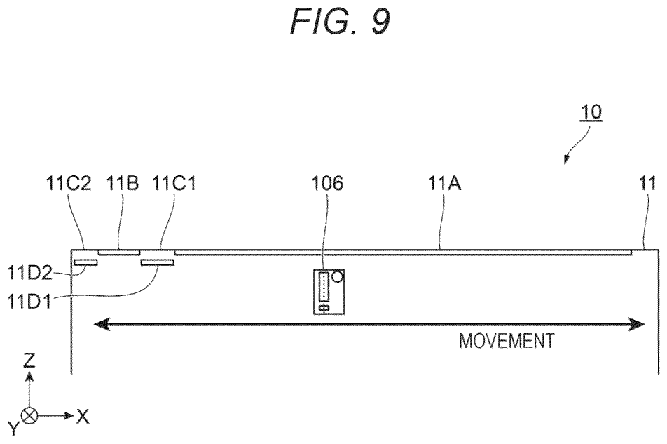

FIG. 9 is an exploded view of the vicinity of the document table 11 of the apparatus body 10 used in a second exemplary embodiment.

In FIG. 9, components corresponding to those in FIG. 3 are denoted by corresponding reference numerals. In the case of the document table 11 illustrated in FIG. 9, the white reference plate 11C2 is attached below the band-shaped member 11C1 and below the band-shaped member 11D2.

Thus, in the case of the present exemplary embodiment, black correction can be performed at any position of the band-shaped member 11C1 and the band-shaped member 11C2.

### Processing Operation

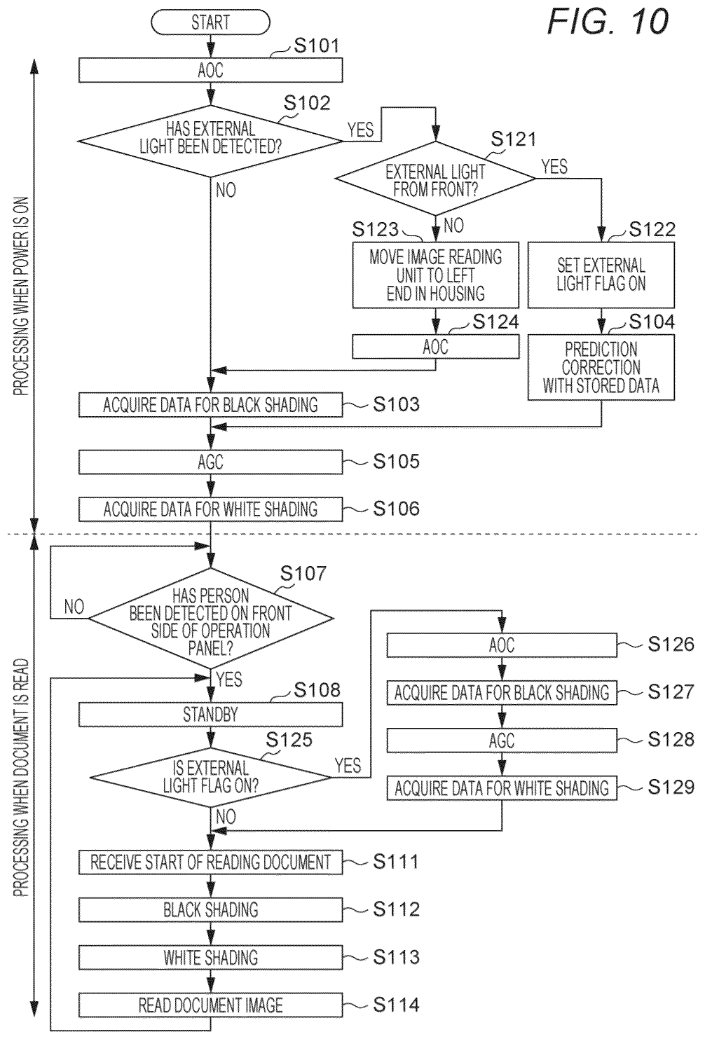

FIG. 10 is a flowchart for describing a processing operation adopted in the second exemplary embodiment. In FIG. 10, components corresponding to those in FIG. 6 are denoted by corresponding reference numerals.

The processing operation illustrated in FIG. 10 is started when an on-operation of the power switch 14 (see FIG. 1) is detected by the processor 101 (see FIG. 2) or when return from a power saving state is detected by the processor 101 (see FIG. 2).

### Processing at the Time of Power-on

First, the processor 101 adjusts the offset amount of black data that is an output value of the image sensor 106C (Step 101). That is, the AOC is executed. The AOC herein is executed at the position of the band-shaped member 11C1 (see FIG. 3).

Next, the processor 101 detects the presence or absence of external light entering the housing from the black data OUT acquired at the time of execution of Step 101 (Step 102). For example, when a pixel in which the difference between the black data OUT and the reference value exceeds a threshold is found, the processor 101 determines that external light entering the housing is detected.

When no external light is detected, a negative result is obtained in Step 102. In this case, the processor 101 acquires data for black shading (Step 103).

On the other hand, when external light is detected, an affirmative result is obtained in Step 102. In this case, the processor 101 determines whether the external light is the external light L2 from the front (Step 121). When only the output value from the pixel position on the front side of the image sensor 106C is larger than the reference value, it is found that the external light entering the housing is the external light L2 from the front side. On the other hand, when the output values from all the pixel positions of the image sensor 106C are larger than the reference value, it is found that the external light entering the housing is the external light L1 from the side surface side.

When it is determined that the external light L2 is incident from the front side, a positive result is obtained in Step 121. In this case, the processor 101 sets an external light flag to ON (Step 122). Next, the processor 101 performs prediction correction with the stored data (Step 104). As described above, data of the output value of the image sensor 106C that is larger than the reference value is replaced with the stored data.

On the other hand, when it is determined that the external light L1 is incident from the side surface side, a negative result is obtained in Step 121. In this case, the processor 101 moves the image reading unit 106 to the left end in the housing (Step 123).

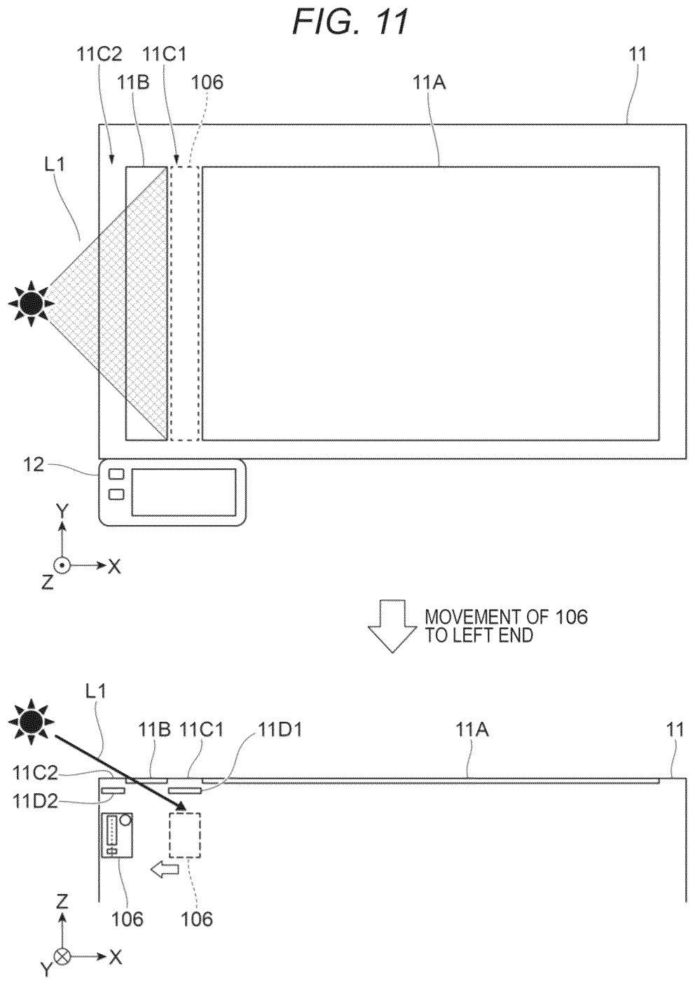

FIG. 11 is a diagram for describing the movement of the image reading unit 106 to the left end in the housing. In FIG. 11, components corresponding to those in FIGS. 3 and 9 are denoted by corresponding reference numerals. The upper part of FIG. 11 illustrates the state of the document table 11 when incidence of external light is detected in Step 102. Thus, the image reading unit 106 is positioned below the band-shaped member 11C1.

On the other hand, the lower diagram of FIG. 11 illustrates a state in which the external light entering the housing is determined to be the external light L1 in Step 121 and the image reading unit 106 is moved to the left end in the housing. As illustrated in the lower diagram, the image reading unit 106 is positioned further to the left than the document reading glass 11B serving as an entrance of the external light L1.

That is, the opening of the imaging lens 106B constituting the image reading unit 106 is positioned further to the left than the left end of the document reading glass 11B. Thus, even when the external light L1 enters the housing, the external light L1 does not affect the image sensor 106C.

Return to the description of FIG. 10.

When the image reading unit 106 moves to the left end in the housing, the processor 101 executes the AOC (Step 124).

Subsequently, the processor 101 acquires data for black shading (Step 103).

After performing Step 103 or after execution of Step 104, the processor 101 automatically adjusts the white gain (Step 105). That is, auto gain control (AGC) is executed. Next, the processor 101 acquires data for white shading (Step 106).

Thus, initial processing associated with power-on ends.

### Processing in Document Reading

Processing operation to be executed each time a document is read will be described below.

First, the processor 101 determines whether a person who operates the operation panel 12 (see FIG. 1) is detected (Step 107).

When no person is detected, a negative result is obtained in Step 107. In this case, a reading operation of the document by a person is not performed. Thus, the processor 101 repeats the determination of Step 107.

On the other hand, when a person is detected, an affirmative result is obtained in Step 107. In this case, the processor 101 enters an operation standby state (Step 108). At this time, the image reading unit 106 is positioned below the band-shaped member 11C1.

Next, the processor 101 determines whether the external light flag is ON (Step 125). When the external light detected in Step 102 is the external light L2 from the front side, a positive result is obtained in Step 125. In this case, the processor 101 executes the AOC again (Step 126), acquires data for black shading (Step 127), executes the AGC (Step 128), and acquires data for white shading (Step 129).

On the other hand, when no external light is detected in Step 102 or when the external light detected in Step 102 is the external light L2 from the side surface side, a negative result is obtained in Step 125.

In this case or after the execution of Step 129, when the processor 101 receives the reading start of the document (Step 111), the processor 101 executes black shading (Step 112) and white shading (step 113), and executes the reading of the document image (Step 114).

When the reading of the document image is completed, the processor 101 returns to Step 108 to prepare for the next reading.

### SUMMARY

The image forming apparatus 1 (see FIG. 1) used in the present exemplary embodiment is also the same as that in the first exemplary embodiment.

Thus, there are two incident paths of external light that affects the correction of the black data OUT. Specifically, the incident path are two gaps, that is, a gap on the left side when the apparatus is viewed from the front and a gap on the front side of the apparatus.

In the case of the image forming apparatus 1 used in the present exemplary embodiment, the white reference plate 11D2 is attached at a left end in the housing when viewed from the front side.

In the case of the present exemplary embodiment, when incidence of the external light L1 is detected in the determination of Step 121, the processor 101 moves the image reading unit 106 in a direction opposite to a document reading direction (that is, the direction toward the left end in the housing) from the first position (that is, the position of the band-shaped member 11C1) for starting the reading of the document in the stationary state. Then, when the image reading unit 106 moves to the second position where the entire light receiving surface of the image sensor 106C is hidden by the housing (that is, the position of the band-shaped member 11C2), the processor 101 corrects the black level of the image sensor 106C again.

On the other hand, when incidence of the external light L2 is detected in the determination of Step 121, the processor 101 corrects the black level of the image sensor 106C by using the normal value (that is, the value not affected by external light) stored at the time of shipment from a factory or the like.

When no incidence of external light is detected in the determination of Step 102, the processor 101 uses the correction result of the black level executed in Step 101 as it is.

As a result, a black level correction technology with less restriction required for the image sensor 106C is realized.

### Third Exemplary Embodiment

### External Configuration and Internal Configuration

Also in the present exemplary embodiment, the image forming apparatus 1 having the appearance configuration illustrated in FIG. 1 is used. The internal configuration of the image forming apparatus 1 is also basically the same as the internal configuration described with reference to FIG. 2.

Also in the case of the present exemplary embodiment, the white reference plate 11C2 is also attached below the band-shaped member 11D2 in the same manner as in the second exemplary embodiment.

### Processing Operation

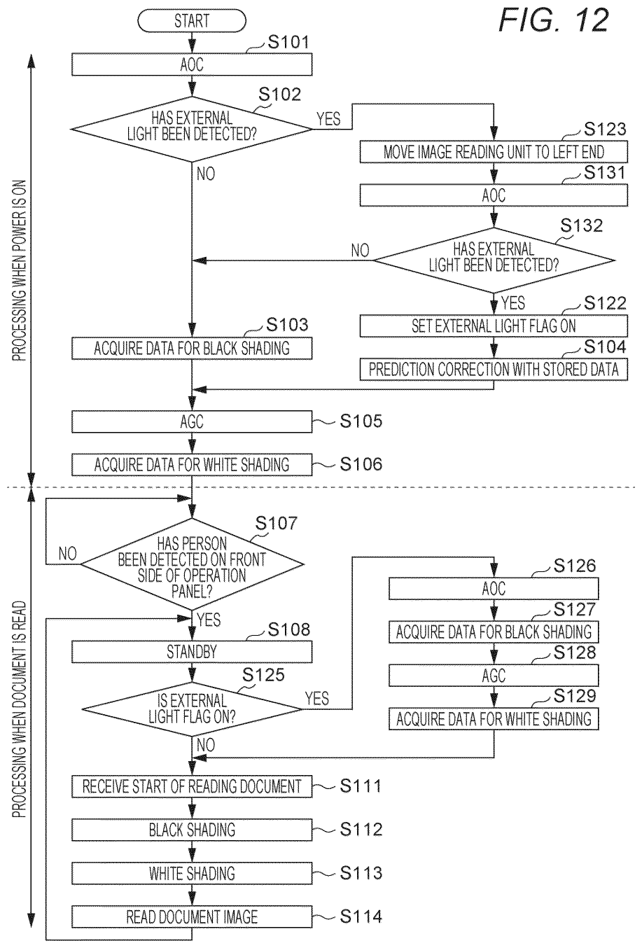

FIG. 12 is a flowchart for describing a processing operation adopted in a third exemplary embodiment. In FIG. 12, components corresponding to those in FIG. 10 are denoted by corresponding reference numerals.

The processing operation illustrated in FIG. 12 is started when an on-operation of the power switch 14 (see FIG. 1) is detected by the processor 101 (see FIG. 2) or when return from a power saving state is detected by the processor 101 (see FIG. 2).

First, the processor 101 adjusts the offset amount of black data that is an output value of the image sensor 106C (Step 101). That is, the AOC is executed. The AOC herein is executed at the position of the band-shaped member 11C1 (see FIG. 3).

Next, the processor 101 detects the presence or absence of external light entering the housing from the black data OUT acquired at the time of execution of Step 101 (Step 102). For example, when a pixel in which the difference between the black data OUT and the reference value exceeds a threshold is found, the processor 101 determines that external light entering the housing is detected.

When no external light is detected, a negative result is obtained in Step 102. In this case, the processor 101 acquires data for black shading (Step 103).

On the other hand, when external light is detected, an affirmative result is obtained in Step 102. In this case, the processor 101 moves the image reading unit 106 to the left end in the housing (Step 123). In the present exemplary embodiment, the image reading unit 106 is moved to the left end in the housing uniformly regardless of whether incidence of external light is from the front side or the side surface side.

Next, the processor 101 executes the AOC (Step 131). The AOC herein is executed at the position of the band-shaped member 11C2 (see FIG. 9). After the execution of the AOC, the processor 101 determines again whether external light is detected (Step 132).

When the external light detected in Step 102 is the external light L1 from the side surface side, a negative result is obtained in Step 132. In this case, the processor 101 proceeds to Step 103 and acquires data for black shading. The data is the data acquired in Step 131.

On the other hand, when the external light detected in Step 102 is the external light L2 from the front side, a positive result is obtained in Step 132.

Although the external light L1 is not directly incident on the position of the left end in the housing, the external light L2 incident through the document reading glass 11B may influence the black level since the presence of a person on the front side of the operation panel 12 is not confirmed at this stage.

In this case, the processor 101 sets an external light flag to ON (Step 122). The processor 101 also performs prediction correction with the stored output data (Step 104).

When Step 103 or Step 104 is executed, the processor 101 automatically adjusts the white gain (Step 105). That is, auto gain control (AGC) is executed.

Next, the processor 101 acquires data for white shading (Step 106).

Thus, initial processing associated with power-on ends.

### Processing in Document Reading

Processing operation to be executed each time a document is read will be described below.

First, the processor 101 determines whether a person who operates the operation panel 12 (see FIG. 1) is detected (Step 107).

When no person is detected, a negative result is obtained in Step 107. In this case, a reading operation of the document by a person is not performed. Thus, the processor 101 repeats the determination of Step 107.

On the other hand, when a person is detected, an affirmative result is obtained in Step 107. In this case, the processor 101 enters an operation standby state (Step 108). At this time, the image reading unit 106 is positioned below the belt-shaped member 11C1.

Next, the processor 101 determines whether the external light flag is ON (Step 125). When the external light detected in Step 102 is the external light L2 from the front side, a positive result is obtained in Step 125.

Since the subsequent processing operation is the same as that of the second exemplary embodiment, the description thereof will be omitted.

### SUMMARY

The image forming apparatus 1 (see FIG. 1) used in the present exemplary embodiment is also the same as that in the second exemplary embodiment.

Thus, there are two incident paths of external light that affects the correction of the black data OUT. Specifically, the incident path are two gaps, that is, a gap on the left side when the apparatus is viewed from the front and a gap on the front side of the apparatus.

Also in the image forming apparatus 1 used in this exemplary embodiment, the white reference plate 11D2 is attached to the left end in the housing as viewed from the front side.

In the case of the present exemplary embodiment, when incidence of external light is detected in the determination of Step 102, the processor 101 moves the image reading unit 106 in a direction opposite to a document reading direction (that is, the direction toward the left end in the housing) from the first position (that is, the position of the belt-shaped member 11C1) for starting reading of a document in the stationary state. Then, when the image reading unit 106 moves to the second position where the entire light receiving surface of the image sensor 106C is hidden by the housing (that is, the position of the band-shaped member 11C2), the processor 101 corrects the black level of the image sensor 106C again.

When incidence of external light is also detected at the second position, the processor 101 corrects the black level of the image sensor 106C using the normal value (that is, a value not affected by external light) stored at the time of shipment from a factory or the like.

When no incidence of external light is detected, the processor 101 uses the correction result of the black level executed in Step 101 as it is.

In this manner, in the case of the present exemplary embodiment, a black level correction technology with less restriction required for the image sensor 106C as compared with the second exemplary embodiment is realized.

### Other Exemplary Embodiments

(1) Although the exemplary embodiments of the present invention have been described above, the technical scope of the present invention is not limited to the scope described in the above-described exemplary embodiments. It is apparent from the description of the scope of claims that various modifications and improvements made to the exemplary embodiments described above are also included in the technical scope of the present invention.

(2) In the description of the above-described exemplary embodiments, the image forming apparatus 1 used in an office has been described, but the image forming apparatus may be a home image forming apparatus capable of reading an image of a document in a stationary state and reading an image of a document conveyed by a mechanism for conveying a document, or may be a scanner capable of reading an image of a document in a stationary state and reading an image of a document conveyed by a mechanism for conveying a document.

(3) In the description of the above-described exemplary embodiments, the CIS type sensor is adopted as the image reading unit 106, but a charge coupled device (CCD) type sensor may also be adopted.

(4) The processor in the above-described exemplary embodiments refers to a processor in a broad sense, and includes a general-purpose processor (for example, a central processing unit (CPU)) and a dedicated processor (for example, a graphical processing unit (GPU), an application specific integrated circuit (ASIC), a field programmable gate array (FPGA), or a program logic device).

The operation of the processor in each of the above-described exemplary embodiments may be executed by one processor alone, or may be executed by a plurality of processors existing at physically separated positions in cooperation with each other. Further, the order of execution of each operation in the processor is not limited to only the order described in each of the above-described exemplary embodiments and may be individually changed.

(5) In the above-described exemplary embodiments, the processor 101 constituting the image forming apparatus 1 independently executes black correction. However, the black correction may be executed in cooperation with a processor of another terminal that can communicate through a network or the like. That is, the above-described processing operation may be realized by cooperation of a plurality of processors.

### Supplementary Note

(((1)))

An information processing system comprising:
a light source that illuminates a document;
an image sensor that reads an image of the document; and
at least one processor,
wherein when incidence of external light is detected from output data of the image sensor, the at least one processor moves the image sensor in a direction opposite to a reading direction from a first position for starting reading of the document in a stationary state, and corrects a black level of the image sensor at a second position where an entire light receiving surface of the image sensor is hidden by a housing.
   (((2)))

The information processing system according to (((1))), wherein the second position is positioned further away from a reading position for reading an image from a document to be conveyed.

(((3)))

The information processing system according to (((1))) or (((2))), wherein the at least one processor detects the presence or absence of external light from an output of the image sensor when a turn-on of a main power is detected or when return from a power saving state is detected.

(((4)))

The information processing system according to any one of (((1))) to (((3))), wherein the at least one processor corrects the black level using output data detected by the image sensor and stored in a state where no external light is present when the presence of external light is detected also at the second position.

(((5)))

The information processing system according to (((4))), wherein the output data detected by the image sensor and stored in a state where no external light is present is data at shipment, at setting, or at a time of execution when the presence of external light is not detected.

(((6)))

The information processing system according to any one of (((1))) to (((5))), wherein the at least one processor corrects the black level using the output data of the image sensor at the first position when a motion sensor detects the presence of a person on a front side of an operation panel even when the presence of external light is detected at the second position.

(((7)))

The information processing system according to (((6))), wherein when the presence of external light is detected also at the second position, the at least one processor does not execute correcting the black level when the motion sensor does not detect the presence of a person on the front side of the operation panel.

(((8)))

A non-transitory computer-readable storage medium storing a program for causing a computer to realize:
a function of moving an image sensor that reads an image of a document in a direction opposite to a document reading direction from a first position for starting reading of the image of the document in a stationary state when the presence of external light is detected from output data of the image sensor; and
a function of correcting a black level of the image sensor at a second position where an entire light receiving surface of the image sensor is hidden by a housing.

What is claimed is:

1. An information processing system comprising:
a light source that illuminates a document;
an image sensor that reads an image of the document; and
at least one processor,
wherein when incidence of external light is detected from output data of the image sensor, the at least one processor moves the image sensor in a direction opposite to a reading direction from a first position for starting reading of the document in a stationary state, and corrects a black level of the image sensor at a second position where an entire light receiving surface of the image sensor is hidden by a housing.

2. The information processing system according to claim 1, wherein
the second position is positioned further away from a reading position for reading an image from a document to be conveyed.

3. The information processing system according to claim 1, wherein
the at least one processor detects the presence or absence of external light from an output of the image sensor when a turn-on of a main power is detected or when return from a power saving state is detected.

4. The information processing system according to claim 2, wherein
the at least one processor detects the presence or absence of external light from an output of the image sensor when a turn-on of a main power is detected or when return from a power saving state is detected.

5. The information processing system according to claim 1, wherein
the at least one processor corrects the black level using output data detected by the image sensor and stored in a state where no external light is present when the presence of external light is detected also at the second position.

6. The information processing system according to claim 5, wherein
the output data detected by the image sensor and stored in a state where no external light is present is data at shipment, at setting, or at a time of execution when the presence of external light is not detected.

7. The information processing system according to claim 1, wherein
the at least one processor corrects the black level using the output data of the image sensor at the first position when a motion sensor detects the presence of a person on a front side of an operation panel even when the presence of external light is detected at the second position.

8. The information processing system according to claim 7, wherein
when the presence of external light is detected also at the second position, the at least one processor does not execute correcting the black level when the motion sensor does not detect the presence of a person on the front side of the operation panel.

9. A non-transitory computer-readable storage medium storing a program for causing a computer to realize:
a function of moving an image sensor that reads an image of a document in a direction opposite to a document reading direction from a first position for starting reading of the image of the document in a stationary state when the presence of external light is detected from output data of the image sensor; and
a function of correcting a black level of the image sensor at a second position where an entire light receiving surface of the image sensor is hidden by a housing.
